(19) United States
(12) Patent Application Publication
(10) Pub. No.: US 2024/0355054 A1
(43) Pub. Date: Oct. 24, 2024

(54) DATA PROCESSING METHOD AND APPARATUS, DEVICE, AND STORAGE MEDIUM

(71) Applicant: Tencent Technology (Shenzhen) Company Limited, Shenzhen (CN)

(72) Inventor: Tianyuan CHANG, Shenzhen (CN)

(73) Assignee: Tencent Technology (Shenzhen) Company Limited, Shenzhen (CN)

(21) Appl. No.: 18/760,630

(22) Filed: Jul. 1, 2024

Related U.S. Application Data
(63) Continuation of application No. PCT/CN2023/113545, filed on Aug. 17, 2023.

(30) Foreign Application Priority Data
Aug. 19, 2022 (CN) 202210997894.0

(51) Int. Cl. G06T 17/20; G06T 5/70; G06T 7/64

(52) U.S. Cl. CPC G06T 17/205; G06T 5/70; G06T 7/64; G06T 2210/16

(57) ABSTRACT

A data processing method, performed by a data processing device, includes: obtaining first graph data of a target object, the first graph data including at least one first mesh data sub-graph including vertexes, wherein each of the at least one first mesh data sub-graph are connected to each other; obtaining smoothness degree data of the vertexes; obtaining second graph data by performing smoothing processing on the first graph data based on the smoothness degree data, the smoothing processing including simplifying a structure of the target object; and determining target weight data based on the second graph data, wherein the target weight data indicates an association degree between one or more joints of the target object and the vertexes.

### CROSS-REFERENCE TO RELATED APPLICATIONS

This application is a continuation application of International Application No. PCT/CN2023/113545 filed on Aug. 17, 2023, which claims priority to Chinese Patent Application No. 202210997894.0, filed with the China National Intellectual Property Administration on Aug. 19, 2022, the disclosures of each being incorporated by reference herein in their entireties.

### FIELD

The disclosure relates to the field of computer technologies, and in particular, to a data processing method, a data processing apparatus, a data processing device, and a computer-readable storage medium.

### BACKGROUND

Clothing skinning is binding vertexes in a three-dimensional Mesh (3D Mesh) of clothing to corresponding joints, for example, to joints of a virtual character, with specific weights, such that clothing of the virtual character may adaptively change based on an action of the virtual character changing.

Existing clothing skinning may produce a skinning effect by directly inputting feature data of a three-dimensional mesh graph of the clothing into a model, and predicting joint weights of vertexes through the model. Due to abundant types of clothing, some types of clothing have complex structures, such as a large number of wrinkles and puffy regions, for example. If the foregoing method is used, efficiency of obtaining the joint weights may be poor, and obtained joint weights may be inaccurate. As a result, an effect of skinning based on the joint weights may also be poor, and abnormal situations such as mis-binding of joints and deformation may occur.

### SUMMARY

Provided are a data processing method and apparatus, a device, and a storage medium, capable of determining target weight data and performing a skinning effect.

According to some embodiments, a data processing method, performed by a data processing device, includes: obtaining first graph data of a target object, the first graph data including at least one first mesh data sub-graph including a plurality of vertexes, wherein each of the at least one first mesh data sub-graph are connected to each other; obtaining smoothness degree data of the plurality of vertexes; obtaining second graph data by performing smoothing processing on the first graph data based on the smoothness degree data, the smoothing processing including simplifying a structure of the target object; and determining target weight data based on the second graph data, wherein the target weight data indicates an association degree between one or more joints of the target object and the plurality of vertexes.

According to some embodiments, a data processing apparatus, includes: at least one memory configured to store computer program code; and at least one processor configured to read the program code and operate as instructed by the program code, the program code including: first obtaining code configured to cause at least one of the at least one processor to obtain first graph data of a target object, the first graph data including at least one first mesh data sub-graph including a plurality of vertexes, wherein each of the at least one first mesh data sub-graph are connected to each other; second obtaining code configured to cause at least one of the at least one processor to obtain smoothness degree data of the plurality of vertexes; first processing code configured to cause at least one of the at least one processor to obtain second graph data by performing smoothing processing on the first graph data based on the smoothness degree data of the plurality of vertexes, the smoothing processing including simplifying a structure of the target object; and second processing code configured to cause at least one of the at least one processor to determine target weight data based on the second graph data, wherein the target weight data indicates an association degree between one or more joints of the target object and the plurality of vertexes.

According to some embodiments, a non-transitory computer-readable storage medium, storing computer code which, when executed by at least one processor, causes the at least one processor to at least: obtain first graph data of a target object, the first graph data including at least one first mesh data sub-graph including a plurality of vertexes, wherein each of the at least one first mesh data sub-graph are connected to each other; obtain smoothness degree data of the plurality of vertexes; obtain second graph data by performing smoothing processing on the first graph data based on the smoothness degree data of the plurality of vertexes, the smoothing processing including simplifying a structure of the target object; and determine target weight data based on the second graph data, wherein the target weight data indicates an association degree between one or more joints of the target object and the plurality of vertexes.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a virtual character and a corresponding three-dimensional mesh according to some embodiments.

FIG. 2 is a schematic diagram of a system architecture according to some embodiments.

FIG. 3 is a schematic flowchart of a data processing method according to some embodiments.

FIG. 4 is a schematic diagram of an unconnected mesh data sub-graph according to some embodiments.

FIG. 5 is a schematic diagram of a vertex position moving process according to some embodiments.

FIG. 6 is a schematic comparison diagram of clothing before and after smoothing processing according to some embodiments.

FIG. 7 is a schematic diagram of application of a target network model according to some embodiments.

FIG. 8 is a schematic flowchart of obtaining first graph data according to some embodiments.

FIG. 9 is a schematic structural diagram of a data processing apparatus according to some embodiments.

FIG. 10 is a schematic structural diagram of a data processing device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Clothing skinning: Vertexes in a three-dimensional mesh (3D Mesh) of clothing are bound to corresponding joints with weights, each vertex may be controlled by one or more bound joints, and joint weights are used to determine the degrees to which the vertex is affected by different joints.

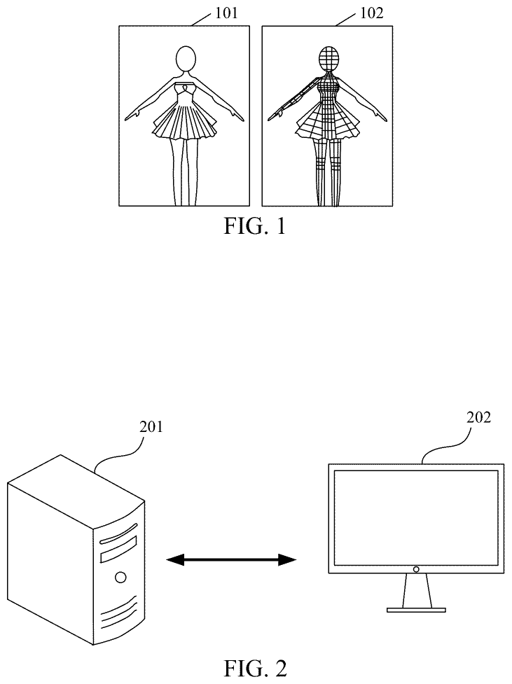

3D Mesh: The 3D Mesh is a concept in computer graphics. The 3D Mesh includes a plurality of vertexes and triangular patches. The 3D Mesh is widely used in games. In a game, skins of different virtual characters with the same mesh precision are mostly bound based on a standard bone structure. A size and a height of the standard bone structure approximately determine positions and coordinates of body regions in the 3D Mesh. As shown in FIG. 1, 101 in FIG. 1 is a presented state of a virtual character, and 102 in FIG. 1 is a 3D Mesh graph corresponding to the virtual character (for example, a virtual character in a box marked by 101).

Joint weights of vertexes: The vertexes in the 3D Mesh are bound to the joints of the virtual character through the joint weights of the vertexes. For example, during movement of the 3D Mesh, the body regions are deformed and stretched under the action of different joint weights.

Some embodiments provide a data processing method, which can efficiently, accurately, and automatically determine joint weights of vertexes of a target object (for example, clothing with a complex structure), thereby improving a skinning effect of the target object. The data processing method provided in some embodiments involves artificial intelligence (AI), cloud technology, Internet of Vehicles technology, and the like.

In some embodiments, the data processing method provided in some embodiments may be implemented based on an AI technology, and may involve a machine learning technology and a computer vision technology in the AI technology. For example, in some embodiments, a network model for predicting the joint weights of the vertexes may be obtained by training based on the AI technology. In some embodiments, the data processing method provided in some embodiments may be implemented based on a cloud technology, and may involve one or more of cloud computing, cloud storage, or a cloud database in the cloud technology. For example, a data processing device in some embodiments may be a cloud server that provides one or more functions of cloud computing, cloud storage, or a cloud database. The data processing device may perform the data processing method based on the cloud technology.

FIG. 2 is a schematic diagram of a system architecture according to some embodiments. The data processing method provided in some embodiments is applicable to the system architecture shown in FIG. 2. As shown in FIG. 2, the data processing system may include a data processing device 201 and a terminal device 202.

The terminal device 202 is a device in which a client providing a clothing skinning function is located, including but is not limited to: a tablet computer, a notebook computer, a desktop computer, a smartphone, or the like. The data processing device 201 includes, but is not limited to: a clothing skinning chip, and the clothing skinning chip may perform skinning processing on graph data of clothing. The data processing device 201 may be embedded in the terminal device 202, or may be an independent device different from the terminal device 202. This is not limited. However, when the data processing device 201 is an independent device, the data processing device 201 may be an independent physical server, or may be a server cluster or a distributed system formed by a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), big data, and an AI platform.

For example, when the data processing device 201 and the terminal device 202 are two independent devices, a user may operate the terminal device 202 to select first graph data (for example, a 3D Mesh graph of clothing) for clothing skinning, and send the first graph data to the data processing device 201. Based on receiving the first graph data, the data processing device 201 processes the first graph data by using the data processing method provided in some embodiments, to obtain second graph data (for example, a graph smoother than a 3D Mesh graph of clothing), and further predicts corresponding target weight data (for example, a joint weight of a vertex) based on the second graph data. The data processing device 201 sends the target weight data to the terminal device 202.

In some embodiments, when the data processing device 201 and the terminal device 202 are two independent devices, graph data of objects may be stored in the data processing device 201. The user operates the terminal device 202 to select first graph data of the target object from the graph data of the objects in the data processing device 201, and the data processing device 201 performs data processing on the first graph data to obtain the target weight data. The data processing device 201 sends the target weight data to the terminal device 202.

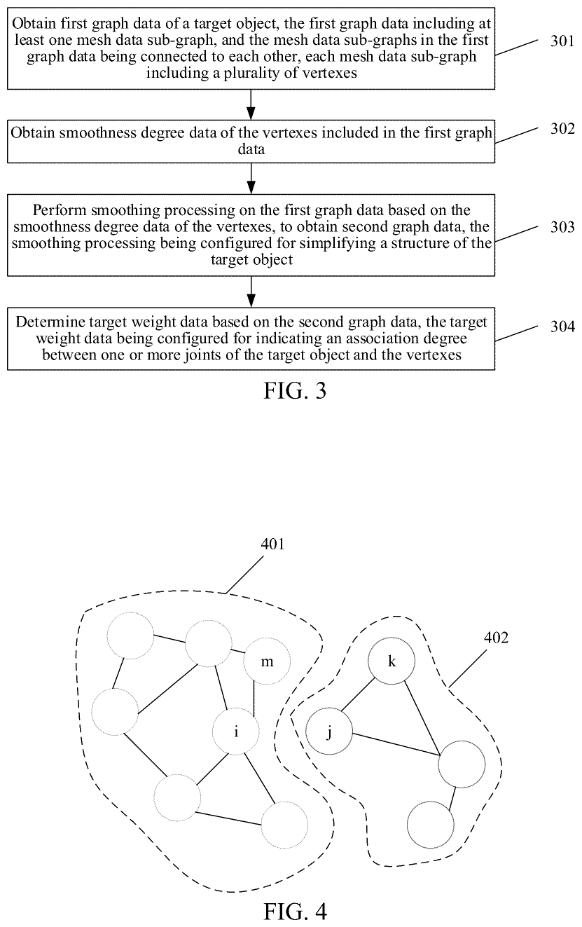

FIG. 3 is a schematic flowchart of a data processing method according to some embodiments. The data processing method may be performed by the foregoing data processing device, including but not limited to the following operations: 301 to 304.

301: Obtain first graph data of a target object, the first graph data including at least one mesh data sub-graph, and the mesh data sub-graphs in the first graph data being connected to each other, each mesh data sub-graph including a plurality of vertexes.

The target object includes to-be-skinned clothing, and the first graph data of the target object includes a 3D Mesh graph of the clothing. As shown in FIG. 1, the target object may be clothing worn by the virtual character in the box marked by 101 in FIG. 1. The first graph data may be a 3D mesh graph corresponding to the clothing in the box marked by 102 in FIG. 1. The mesh data sub-graph is a mesh graph generated by a connection relationship between the plurality of vertexes. As shown in FIG. 4, 401 in FIG. 4 is a connected mesh data sub-graph. The vertexes included in the mesh data sub-graph 401 are a vertex i and other vertexes (circles in FIG. 4). The vertexes in the mesh data sub-graph 401 may exist in different horizontal planes, for example, heights of the vertexes may be different. The mesh data sub-graph includes not only the plurality of vertexes, but also a plurality of patches and a plurality of connecting edges. For some embodiments of obtaining the first graph data of the target object, refer to descriptions of some embodiments.

302: Obtain smoothness degree indication data of the vertexes included in the first graph data.

The smoothness degree indication data of a vertex is configured for indicating a smoothness degree of curvature of a curved surface around the vertex. Larger smoothness degree indication data of a vertex may indicate a sharper surface around the vertex, and smaller smoothness degree indication data of the vertex indicates a smoother surface around the vertex. In some embodiments, the smoothness degree indication data may be a discrete average curvature; and the discrete average curvature of any vertex may reflect the smoothness degree of curvature of the curved surface around the vertex. A larger discrete average curvature of the vertex indicates a sharper surface around the vertex, and a smaller discrete average curvature of the vertex indicates a smoother surface around the vertex.

In some embodiments, when the smoothness degree indication data is the discrete average curvature, operation 302 may include: obtaining any two orthogonal curvatures of each vertex that are perpendicular to each other in the first graph data; determining an average value of the two orthogonal curvatures that are perpendicular to each other; and determining the discrete average curvature of the vertex based on the average value of the orthogonal curvatures.

To understand the discrete average curvature involved in some embodiments, content related to curvature is explained below. A normal curvature, an average curvature, a principal curvature, and a Gaussian curvature are several elements of the curvature. Normal curvature: It is a quantity that describes a degree of curvature of a curved surface in a direction, for example, the degree of curvature of the curved surface in a direction at a point, or a speed at which the curved surface leaves a tangent plane. Principal curvature: There are an infinite number of orthogonal curvatures at a point on a curved surface. A curve exists such that a curvature of the curve is maximum. This curvature is a maximum value, and a curvature perpendicular to the maximum curvature is a minimum value. These two curvatures are considered as principal curvatures. The two curvatures represent extreme values of the normal curvature. Average curvature: It is an average value of any two orthogonal curvatures perpendicular to each other at a point on a curved surface in space. Gaussian curvature: A product of two principal curvatures is the Gaussian curvature, which is also referred to as a total curvature, and reflects a total degree of curvature at a point. The discrete average curvature of the vertex may be the foregoing average curvature, or may be the foregoing Gaussian curvature, or may be another curvature. For example, the smoothness degree indication data of the vertex mentioned in some embodiments may be various data for indicating a smoothness degree of curvature of a curved surface around the vertex, including but not limited to, an average curvature of the vertex, a Gaussian curvature, a normal curvature, a principal curvature of the vertex, and the like. This is not limited. In some embodiments, the discrete average curvature of the vertex is described by using the average curvature of the vertex as an example.

For example, a formula for calculating the discrete average curvature of any vertex may be as follows:

$$H = \frac{1}{2} ( {k}_{1} + {k}_{2} )$$

Any vertex on the curved surface has an infinite number of orthogonal curvatures. A curve exists such that a curvature of the curve is maximum. This curvature is a maximum value k₁, and a curvature perpendicular to the maximum curvature is a minimum value k₂. The two curvatures k₁ and k₂ are principal curvatures and represent extreme values of the normal curvature. H is a discrete average curvature of any vertex.

303: Perform smoothing processing on the first graph data based on the smoothness degree indication data of the vertexes, to obtain second graph data. The smoothing processing is configured for simplifying a structure of the target object.

The second graph data is graph data smoother than the first graph data. Smoothness degree indication data of vertexes in the second graph data may be smaller than smoothness degree indication data of vertexes in the first graph data. The second graph data further includes at least one mesh data sub-graph, and the mesh data sub-graphs in the second graph data are connected to each other, each mesh data sub-graph including a plurality of vertexes. The number of vertexes included in the first graph data may be the same as the number of vertexes included in the second graph data.

In some embodiments, the smoothness degree indication data includes the discrete average curvature. The performing smoothing processing on the first graph data based on the smoothness degree indication data of the vertexes, to obtain second graph data is: obtaining a preset curvature threshold set, the preset curvature threshold set including K curvature thresholds, K being a positive integer greater than 1; performing, based on the K curvature thresholds and the discrete average curvature of the vertexes in the first graph data, smoothing processing on the first graph data, to obtain K pieces of smooth graph data; and determining the second graph data based on K pieces of smooth graph data.

The preset curvature threshold set includes K curvature thresholds, and values of the K curvature thresholds are different. The smooth graph data is graph data obtained by performing smoothing processing on the first graph data based on any curvature threshold and the discrete average curvatures of the vertexes in the first graph data. The K curvature thresholds are in a one-to-one correspondence with the K pieces of smooth graph data.

For example, the preset curvature threshold set includes three curvature thresholds: a curvature threshold A, a curvature threshold B, and a curvature threshold C. Based on the three curvature thresholds and the discrete average curvatures of the vertexes in the first graph data, smoothing processing is performed on the first graph data to obtain three smooth graph data: for example, smooth graph data A, smooth graph data B, and smooth graph data C. The smooth graph data A is obtained based on the curvature threshold A and the discrete average curvatures of the vertexes in the first graph data. Therefore, the smooth graph data A is in a one-to-one correspondence with the curvature threshold A. The smooth graph data B is obtained based on the curvature threshold B and the discrete average curvatures of the vertexes in the first graph data. Therefore, the smooth graph data B is in a one-to-one correspondence with the curvature threshold B. The smooth graph data C is obtained based on the curvature threshold C and the discrete average curvatures of the vertexes in the first graph data. Therefore, the smooth graph data C is in a one-to-one correspondence with the curvature threshold C.

To understand a preset adjustment policy involved in some embodiments, adjustment policies are explained below. There may be three adjustment policies: a Laplacian smoothing algorithm, a two-step smoothing algorithm, and a deep smoothing algorithm. The two-step smoothing algorithm may include smoothing a normal of the curved surface to obtain a new normal, and moving the vertex to a position for the new normal, to complete smoothing of the curved surface. However, when data is inputted into a model (for example, a target network model for predicting a joint weight of a vertex) through the two-step smoothing algorithm, a topology of the model may be damaged. The depth smoothing algorithm is similar to the two-step smoothing in that a normal is changed first, and a position of a vertex is changed. However, in comparison with the two-step smoothing algorithm, in the depth smoothing algorithm, the vertex is moved in only one given direction. However, the deep smoothing algorithm may still damage the topology of the model. The preset adjustment policy in some embodiments may be based on improvements to the Laplacian smoothing algorithm. The Laplacian smoothing algorithm is explained in detail below.

Laplacian smoothing algorithm: The position of the vertex is constantly adjusted by a plurality of iterations based on a position relationship of neighboring vertexes in a mesh to improve a shape and quality of the mesh. The formula is expressed as follows:

p^{(m)}=p^{(m-1)}−λLP^{(m-1)}

$$L ( {p}_{i} ) = \frac{1}{{\sum }_{j ϵ {N}_{i}} {w}_{ij}} ( {\sum }_{j ϵ {N}_{i}} {w}_{ij} {p}_{j} ) - {p}_{i}$$

where m represents the number of algorithm iterations, and P^{(m)} represents a vertex position of the vertex after m iterations. λ is a parameter in a range of [0, 1]. A larger value of λ indicates that a position of a surrounding neighboring vertex has a larger impact on a position update of the vertex. L is a Laplacian matrix, and determines an update direction of a position of each vertex. w is a weight of an impact of a neighboring vertex on a position of the vertex in the Laplacian matrix. In the foregoing formula, L (pᵢ) is a Laplacian vector representation of a vertex i. Wᵢⱼ is a weight of a neighboring vertex j of the vertex i to a position of the vertex i. There are two calculation methods for Wᵢⱼ: a uniform weight calculation method and a cotangent weight calculation method. The uniform weight calculation method is to directly set Wᵢⱼ=1. Some embodiments may use the cotangent weight calculation method. A calculation formula of the cotangent weight calculation method is as follows:

$${w}_{ij} = \frac{1}{2} ( cot {∝}_{ij} + cot {β}_{ij} )$$

where ∝ and β refer to two diagonals of a triangle associated with a connecting edge between the vertex i and the neighboring vertex j.

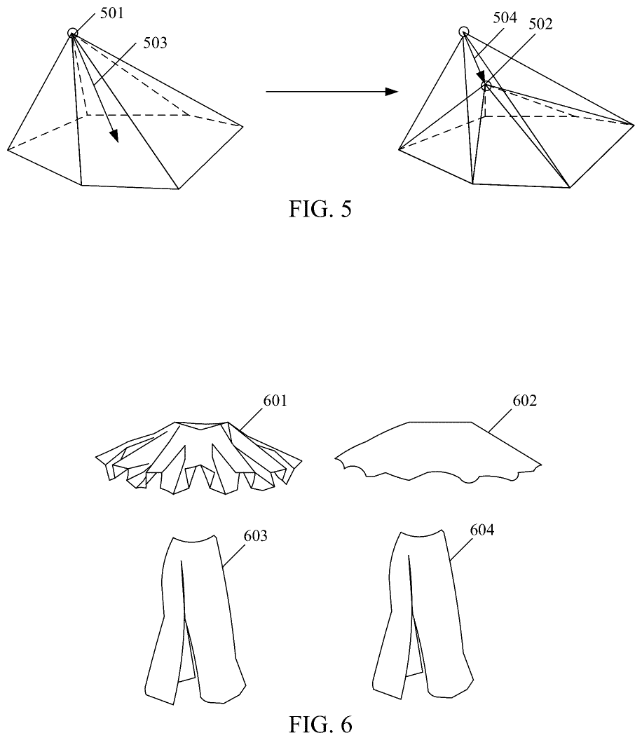

For example, as shown in FIG. 5, FIG. 5 is a schematic diagram of an adjustment process of a vertex position based on the foregoing Laplacian smoothing algorithm. In FIG. 5, 501 is an initial position 501 of the vertex, and 502 is a new position 502 of the vertex after adjustment. 503 is L (Laplacian matrix), and determines an update direction of the vertex position. 504 is λL.

Although the Laplacian smoothing algorithm can remove redundant information such as wrinkles for complex clothing with wrinkles, to make the curved surface of the clothing smoother, the Laplacian smoothing algorithm has a significant problem of abnormal collapse in a structure originally having a smooth curved surface (such as a flag structure and a waistband structure) in the clothing. Therefore, to implement smoothing processing on relatively smooth clothing and maintain a normal shape of the original clothing, some embodiments improve the foregoing Laplacian smoothing algorithm to provide a new smoothing algorithm. The new smoothing algorithm may be as described below.

In some embodiments, the performing, based on the K curvature thresholds, smoothing processing on the first graph data, to obtain K pieces of smooth graph data is: determining, from the first graph data based on an i^{th} curvature threshold in the preset curvature threshold set, a to-be-adjusted vertex with the discrete average curvature greater than the i^{th} curvature threshold, i being a positive integer greater than 0 and less than or equal to K; and adjusting a position of the to-be-adjusted vertex based on a preset adjustment policy to obtain smooth graph data corresponding to the i^{th} curvature threshold.

The discrete average curvature of the to-be-adjusted vertex is greater than the curvature threshold, for example, the to-be-adjusted vertex is not smooth enough. The preset adjustment policy may be the foregoing Laplacian smoothing algorithm.

In some embodiments, a to-be-adjusted vertex with the discrete average curvature greater than an i^{th} curvature threshold is determined from the first graph data based on the i^{th} curvature threshold in the preset curvature threshold set; a position of the to-be-adjusted vertex is adjusted based on the preset adjustment policy, until a number of adjustments satisfy a preset number of iterations; and smooth graph data corresponding to the i^{th} curvature threshold is obtained.

For example, the first graph data includes five vertexes: a vertex 1, a vertex 2, a vertex 3, a vertex 4, and a vertex 5. The discrete average curvature of the vertex 1 is 40, the discrete average curvature of the vertex 2 is 38, the discrete average curvature of the vertex 3 is 45, the discrete average curvature of the vertex 4 is 50, and the discrete average curvature of the vertex 5 is 35. The i^{th} curvature threshold in the preset curvature threshold set is 42. To-be-adjusted vertexes determined from the foregoing first graph data based on the i^{th} curvature threshold in the preset curvature threshold set are: the vertex 3 and the vertex 4. If the preset number of iterations is 3, the positions of the vertex 3 and the vertex 4 are adjusted for three times based on the preset adjustment policy, and the positions of the vertex 1, the vertex 2, and the vertex 5 are not adjusted. The adjusted graph data is used as smooth graph data corresponding to the i^{th} curvature threshold.

In some embodiments, adjustment may be performed based on each curvature threshold in the K curvature thresholds. For example, when the i^{th} curvature threshold is not the last curvature threshold, after the position of the vertex is adjusted based on the i^{th} curvature threshold, the position of the vertex is further adjusted based on an (i+1)^{th} curvature threshold, until the position of the vertex has been adjusted based on all the curvature thresholds.

In some embodiments, after adjustment based on the i^{th} curvature threshold is completed, smooth graph data obtained based on the i^{th} curvature threshold is saved, and each vertex position is initialized to an original vertex position. Adjustment is performed based on the (i+1)^{th} curvature threshold. For example, each adjustment is made on the original vertex positions of the vertexes in the first graph data, not on the position adjusted last time.

For example, three vertex positions in the first graph data are as follows: the vertex 1 (14, 37, 128), the vertex 2 (20, 39, 119), and the vertex 3 (12, 26, 147). Positions of the three vertexes in the smooth graph data obtained by adjusting the to-be-adjusted vertexes in the first graph data based on the i^{th} curvature threshold are as follows: the vertex 1 (13, 37, 120), the vertex 2 (20, 39, 119), and the vertex 3 (7, 19, 123). After the adjustment based on the i^{th} curvature threshold is completed, and when adjustment is performed on the first graph data based on the (i+1)^{th} curvature threshold, coordinates of the three vertexes are still the vertex 1 (14, 37, 128), the vertex 2 (20, 39, 119), and the vertex 3 (12, 26, 147).

Because complex clothing of various different styles and designs may have a large difference in shape, a given reference curvature cannot adapt to all clothing shapes. In some embodiments, a preset curvature threshold set is preset, and preset adjustment policies are sequentially generated for the clothing based on the curvature thresholds in the preset curvature threshold set, to adapt to the various clothing shapes. By using a given reference curvature set (for example, the preset curvature threshold set), a reference curvature (for example, a curvature threshold in the preset curvature threshold set) may be adaptively selected for objects such as complex clothing or characters with different styles and designs to update vertex positions of the objects.

In some embodiments, the determining the second graph data based on the K pieces of smooth graph data is: respectively calculating the vertex average curvature corresponding to each smooth graph data in the K pieces of smooth graph data, to obtain K vertex average curvatures; and determining the second graph data from the K pieces of smooth graph data based on the K vertex average curvatures.

The vertex average curvature corresponding to each smooth graph data is an average value of the discrete average curvatures of the vertexes in the smooth graph data.

In some embodiments, the vertex average curvature may also be a median of the discrete average curvatures of the vertexes in the smooth graph data, or may be a variance of the discrete average curvatures of the vertexes in the smooth graph data. This is not limited herein.

In some embodiments, the vertex average curvature corresponding to each smooth graph data in the K pieces of smooth graph data is respectively calculated, to obtain K vertex average curvatures; a vertex average curvature with a smallest value is selected from the K vertex average curvatures; and smooth graph data corresponding to the vertex average curvature with a smallest value is determined as the second graph data.

For example, there are three pieces of smooth graph data: smooth graph data 1, smooth graph data 2, and smooth graph data 3. The vertex average curvature corresponding to the smooth graph data 1 is 50; the vertex average curvature corresponding to the smooth graph data 2 is 47; and the vertex average curvature corresponding to the smooth graph data 3 is 51. In the three pieces of smooth graph data, the smooth graph data with the smallest average curvature is the smooth graph data 2, and the smooth graph data 2 is used as the second graph data.

For example, there are three pieces of smooth graph data: smooth graph data 1, smooth graph data 2, and smooth graph data 3. The vertex average curvature corresponding to the smooth graph data 1 is 43; The vertex average curvature corresponding to the smooth graph data 2 is 47; and the vertex average curvature corresponding to the smooth graph data 3 is 49. In the three pieces of smooth graph data, the smooth graph data with the smallest average curvature is the smooth graph data 1, and the smooth graph data 1 is used as the second graph data.

For example, there are three pieces of smooth graph data: smooth graph data 1, smooth graph data 2, and smooth graph data 3. The vertex average curvature corresponding to the smooth graph data 1 is 56; the vertex average curvature corresponding to the smooth graph data 2 is 53; and the vertex average curvature corresponding to the smooth graph data 3 is 52. In the three pieces of smooth graph data, the smooth graph data with the smallest average curvature is the smooth graph data 3, and the smooth graph data 3 is used as the second graph data.

The smooth graph data with the smallest vertex average curvature is used as the second graph data, so that the second graph data is more smooth. Smoother graph data means less complex structures, thereby making the determined target weight data more accurate. As shown in FIG. 6, clothing 601 in FIG. 6 is clothing with a complex structure. Clothing 602 obtained by performing the smoothing processing provided in some embodiments on the clothing 301 is smoother. Clothing 603 in FIG. 6 is a relatively smooth clothing. Clothing 604 obtained by performing the smoothing processing provided in some embodiments on the clothing 603 does not have abnormal deformation or collapse.

In some embodiments, the smoothness degree indication data includes the discrete average curvature. The performing smoothing processing on the first graph data based on the smoothness degree indication data of the vertexes, to obtain second graph data is: obtaining a preset curvature threshold mapping table, the preset curvature threshold mapping table including a mapping relationship between a curvature threshold and a vertex average curvature range; calculating a vertex average curvature corresponding to the first graph data; determining a target curvature threshold based on the vertex average curvature and the preset curvature threshold mapping table; and performing smoothing processing on the first graph data based on the target curvature threshold, and using the processed first graph data as the second graph data.

The curvature threshold mapping table includes curvature thresholds and vertex average curvature ranges, and the curvature thresholds are in a one-to-one correspondence with the vertex average curvature ranges. The vertex average curvature may be an average value of the discrete average curvatures of the vertexes in the first graph data, or may be a median of the discrete average curvatures of the vertexes in the first graph data, or may be a variance of the discrete average curvatures of the vertexes in the first graph data. This is not limited herein.

In some embodiments, for smoothing processing, reference may be made to the foregoing process of determining the to-be-adjusted vertexes in the first graph data based on the curvature thresholds, and adjusting the to-be-adjusted vertexes based on the preset adjustment policy.

For example, the vertex average curvature corresponding to the first graph data is calculated to be: 48. The curvature threshold mapping table is as follows:

| Vertex average curvature range | Curvature threshold |
|---|---|
| First vertex average curvature range: | First curvature threshold: 37 |
| 35-40 | |
| Second vertex average curvature range: | Second curvature threshold: 42 |
| 40-45 | |
| Third vertex average curvature range: | Third curvature threshold: 47 |
| 45-50 | |
| Fourth vertex average curvature range: | Fourth curvature threshold: 52 |
| 50-55 | |

As the vertex average curvature (48) corresponding to the first graph data falls within the third vertex average curvature range (45-50), it is determined that the curvature threshold corresponding to the first graph data is the third curvature threshold (47). Based on the third curvature threshold, smoothing processing is performed on the first graph data, and the processed first graph data is used as the second graph data.

Based on the curvature threshold being determined through the curvature threshold mapping table and the vertex average curvature, smoothing processing is performed on the first graph data based on the determined curvature threshold, thereby improving efficiency of the smoothing processing, so that the second graph data may be determined more quickly.

304: Determine target weight data based on the second graph data, the target weight data being configured for indicating an association degree between each joint of the target object and the vertexes.

The target weight data may be a joint weight of a vertex. The target weight data is configured for determining degrees to which the vertex is affected by different joints during movement of the target object.

In some embodiments, first graph data of a target object is obtained, the first graph data of the target object including at least one mesh data sub-graph, and the mesh data sub-graphs in the first graph data being connected to each other. If the mesh data sub-graphs in the first graph data are unconnected to each other, abnormal deformation of clothing is generated due to a large distance between the unconnected mesh data sub-graphs. Therefore, the mesh data sub-graphs included in the first graph data are connected to each other, which ensures that the abnormal deformation of the clothing is not generated due to a distance. Smoothness degree indication data of vertexes included in the first graph data is obtained, and smoothing processing is performed on the first graph data based on the smoothness degree indication data of the vertexes, to obtain second graph data. Smoothing processing is performed on the first graph data of the target object, so that proper smoothing and collapsing may be performed on a complex structure in the first graph data (for example, a wrinkled part and a puffy region of clothing). In a case of ensuring an original shape of an original smooth region of the target object does not change, a structure of the target object is simplified, so that the target object obtained based on smoothing processing has a simpler structure, and abnormal shape of clothing caused by the complex structure is avoided. Target weight data is determined based on the second graph data. Because the second graph data is data obtained based on smoothing processing, complexity of the second graph data is reduced, so that the determined target weight data is more accurate. Regardless of whether the target object includes a highly complex structure, the target weight data can be accurately determined, thereby improving the skinning effect of the target object.

In some embodiments, after the target weight data is determined based on the second graph data, the target object may be further skinned based on the target weight data.

In some embodiments, based on the target object being clothing worn by the virtual character, a vertex in the 3D Mesh graph corresponding to the clothing is bound to a joint of the virtual character based on the target weight data, so that when an action of the virtual character changes, the clothing adaptively changes accordingly.

In some embodiments, the determining target weight data based on the second graph data is: performing feature extraction on the second graph data to obtain target feature data; and calling a target network model to perform prediction processing on the target feature data to obtain the target weight data, the target network model being obtained by training an initialized neural network based on sample graph data of a sample object and annotated weight data, and the sample graph data being obtained by performing connection processing and smoothing processing on the sample graph data of the sample object.

The target feature data may include positions of vertexes in the second graph data, and the target feature data may further include distances between the vertexes in the second graph data and a joint of the target object. The target network model is a pre-trained model. An initialized neural network may be a convolutional neural network (CNN).

To understand the target network model involved in some embodiments, the following further explains the convolutional neural network. The convolutional neural network may be formed by the following types of layers: an input layer, a convolutional layer, a down-sampling layer, a pooling layer, and a fully connected layer. A convolutional neural network may be constructed by superimposing these layers. The convolutional layer is a core layer for constructing the convolutional neural network. Parameters of the convolutional layer are formed by some learnable filter sets.

With reference to the foregoing explanation of the convolutional neural network, the following further explains a process of training the target network model. The parameters in the convolutional neural network are initialized, and feature extraction is performed on the sample graph data of the sample object to obtain sample feature data. The sample feature data is inputted into the initialized convolutional neural network. In the convolutional neural network, forward propagation is performed on the sample feature data through the convolutional layer, the downsampling layer, and the fully connected layer to obtain outputted sample weight data. An error between the sample weight data and preset weight data is calculated. Based on the error being greater than an expected value, the error is transmitted back to the convolutional neural network, and errors of the fully connected layer, the down-sampling layer, and the convolutional layer are calculated in sequence. The parameters of the convolutional neural network are updated based on the errors of the layers. When the error is less than the expected value, the training ends.

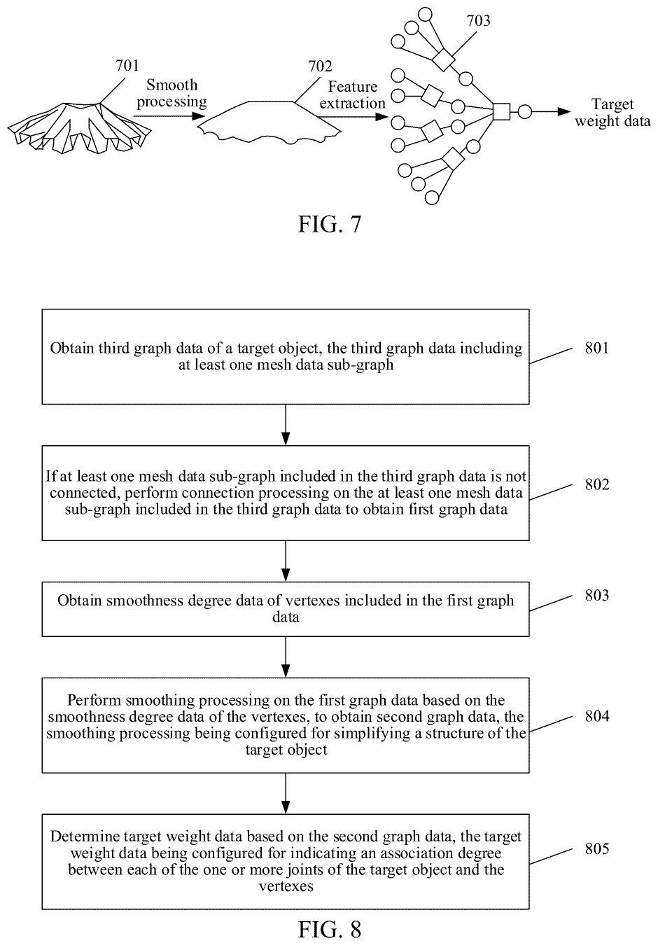

For example, a process of using the target network model is shown in FIG. 7. In FIG. 7, 701 is first graph data 701, 702 is second graph data 702, and 703 is a target network model 703. Smoothing processing is performed on the first graph data 701 to obtain second graph data 702. The second graph data 702 is inputted into the target network model 703, and the target network model 703 outputs target weight data.

The foregoing embodiments describe how to perform smoothing processing on the first graph data, and how to determine the target weight data based on the second graph data. With reference to FIG. 8, how to obtain the first graph data of the target object is further explained below.

FIG. 8 is a schematic flowchart of obtaining first graph data according to some embodiments. The procedure may be performed by the foregoing data processing device. The procedure includes, but is not limited to, the following operations: 801 to 805.

801: Obtain third graph data of the target object, the third graph data including at least one mesh data sub-graph.

The third graph data is initial graph data of the target object. The third graph data may be one connected mesh data sub-graph, or the third graph data may be a plurality of mesh data sub-graphs that are not connected to each other.

802: If at least one mesh data sub-graph included in the third graph data is not connected, perform connection processing on the at least one mesh data sub-graph included in the third graph data to obtain the first graph data.

Any vertex in the mesh data sub-graph and another vertex in the mesh data sub-graph include at least one connecting edge. If at least one mesh data sub-graph included in the third graph data is not connected to each other, a plurality of mesh data sub-graphs included in the third graph data are not connected to each other, but each mesh data sub-graph is internally connected. For example, as shown in FIG. 4, FIG. 4 shows two mesh data sub-graphs included in the third graph data. The mesh data sub-graph 401 and the mesh data sub-graph 402 are not connected to each other, but the mesh data sub-graph 401 and the mesh data sub-graph 402 are each internally connected.

In some embodiments, the performing connection processing on the at least one mesh data sub-graph included in the third graph data to obtain the first graph data is: determining a to-be-connected vertex pair from the third graph data based on a preset initial connection distance value and a preset iteration accumulation distance parameter, the to-be-connected vertex pair including a first vertex and a second vertex, and the first vertex and the second vertex being located in different mesh data sub-graphs in the third graph data; determining, from the third graph data based on the first vertex and the second vertex, a first neighboring vertex neighboring to the first vertex and a second neighboring vertex neighboring to the second vertex; and performing update processing on a connecting edge and a patch of the third graph data based on the first vertex, the second vertex, the first neighboring vertex, and the second neighboring vertex, to obtain the first graph data. Update processing herein refers to: adding new connecting edges and patches between vertexes having no connecting edge in the first vertex, the second vertex, the first neighboring vertex, and the second neighboring vertex, so as to realize the update processing of the connecting edges and the patches of the third graph data.

The initial connection distance value is a preset initial determination threshold, and the iteration accumulation distance parameter is configured for adjusting the initial connection distance value in the connection process. A process of determining a to-be-connected vertex pair based on the third graph data may be a cyclic process: determining the to-be-connected vertex pair from the third graph data based on the initial connection distance value; determining the to-be-connected vertex pair from the third graph data based on a value obtained by adding the initial connection distance value and the iteration accumulation distance parameter; and determining the to-be-connected vertex pair from the third graph data based on a value obtained by adding the initial connection distance value and two iteration accumulation distance parameters. The two vertexes (the first vertex and the second vertex) included in the to-be-connected vertex pair are not in a same mesh data sub-graph. As shown in FIG. 4, a vertex i and a vertex j in FIG. 4 may be used as a to-be-connected vertex pair, and the vertex i and the vertex j are located in different mesh data sub-graphs. The first neighboring vertex is a neighboring vertex of the first vertex that is closest to the first vertex in a same mesh data sub-graph, for example, there is a connecting edge between the first neighboring vertex and the first vertex. Similarly, the second neighboring vertex is a neighboring vertex of the second vertex that is closest to the second vertex in a same mesh data sub-graph, for example, there is a connecting edge between the second neighboring vertex and the second vertex. The connecting edge is configured for connecting two vertexes. The patch is formed by a plurality of connecting edges.

For example, the foregoing connection processing is further explained with reference to FIG. 4. The third graph data includes two mesh data sub-graphs as shown in FIG. 4: a mesh data sub-graph 401 and a mesh data sub-graph 402. Based on a preset initial connection distance value and a preset iteration accumulation distance parameter, a to-be-connected vertex pair is determined from the third graph data. The to-be-connected vertex pair includes the vertex i and the vertex j in FIG. 4, the vertex i is in the mesh data sub-graph 401, and the vertex j is in the mesh data sub-graph 402. It is determined from the mesh data sub-graph 401 that a neighboring vertex closest to the vertex i is a vertex m, and it is determined from the mesh data sub-graph 402 that a neighboring vertex closest to the vertex j is a vertex k. Based on the vertex i, the vertex j, the vertex m, and the vertex j, update processing is performed on the connecting edges and the patches of the third graph data to obtain the first graph data.

In some embodiments, the performing connection processing on the at least one mesh data sub-graph included in the third graph data to obtain the first graph data is: annotating a same identifier for vertexes located in a same mesh data sub-graph in the third graph data, and annotating different identifiers for vertexes located in different mesh data sub-graphs in the third graph data; determining a to-be-connected vertex pair from the third graph data based on the identifier, the preset initial connection distance value, and the preset iteration accumulation distance parameter, the to-be-connected vertex pair including a first vertex and a second vertex, and the first vertex and the second vertex carry different identifiers; determining, from the third graph data based on the first vertex and the second vertex, a first neighboring vertex neighboring to the first vertex and a second neighboring vertex neighboring to the second vertex, the first neighboring vertex carries the same identifier as the first vertex, and the second neighboring vertex carries the same identifier as the second vertex; and performing update processing on a connecting edge and a patch of the third graph data based on the first vertex, the second vertex, the first neighboring vertex, and the second neighboring vertex, to obtain the first graph data.

For example, the third graph data includes two mesh data sub-graphs as shown in FIG. 4: a mesh data sub-graph 401 and a mesh data sub-graph 402. An identifier A is annotated for 7 vertexes in the mesh data sub-graph 401, and an identifier B is annotated for 4 vertexes in the mesh data sub-graph 402. Based on the identifier A, identifier B, the preset initial connection distance value, and the preset iteration accumulation distance parameter, the to-be-connected vertex pair is determined from the third graph data. For a process of obtaining the first graph data based on the to-be-connected vertex pair, reference may be made to the foregoing descriptions.

In some embodiments, the determining a to-be-connected vertex pair from the third graph data based on a preset initial connection distance value and a preset iteration accumulation distance parameter is: determining one or more connection determination values based on the preset initial determination value and the preset iteration distance parameter; obtaining a distance between any two vertexes located in different mesh data sub-graphs in the third graph data; and determining, based on the one or more connection determination values and the distance between the any two vertexes, the first vertex and the second vertex from the vertexes included in the third graph data, and using the first vertex and the second vertex as the to-be-connected vertex pair.

The connection determination value is configured for determining whether to connect two vertexes located in different mesh data sub-graphs. a distance between any two vertexes is a length of a connecting edge between the two vertexes.

In some embodiments, a first connection determination value is determined based on the preset initial determination value and the preset iteration distance parameter; a distance between any two vertexes located in different mesh data sub-graphs in the third graph data is obtained; the first vertex and the second vertex are determined from the third graph data based on the first connection determination value and the distance between the any two vertexes, and the first vertex and the second vertex are used as a to-be-connected vertex pair; update processing is performed on a connecting edge and a patch of the third graph data based on the to-be-connected vertex pair; if the processed third graph data still includes a plurality of mesh data sub-graphs, a second connection determination value is determined based on the preset initial determination value and the preset iteration distance parameter; and the foregoing operation is repeated based on based on the second connection determination value to perform update processing again until the third graph data includes only one mesh data sub-graph, and the third graph data is used as the first graph data.

In some embodiments, a method for determining the first vertex and the second vertex from the third graph data based on the first connection determination value and the distance between the any two vertexes may be as follows: The first connection determination value is compared with a distance between any two vertexes located in different mesh data sub-graphs in the third graph data. If the first connection determination value is greater than the distance between the two vertexes, it is determined that the two vertexes are the first vertex and the second vertex, and if the first connection determination value is less than the distance between the two vertexes, the next two vertexes are determined.

For example, the preset initial determination value is 1, the iteration distance parameter is 0.5, and the third graph data includes four mesh data sub-graphs: a mesh data sub-graph 1, a mesh data sub-graph 2, a mesh data sub-graph 3, and a mesh data sub-graph 4. The preset initial determination value (1) is compared with the distance between any two vertexes located in different mesh data sub-graphs in the third graph data. The vertexes between which the distance is less than the preset initial determination value are: the vertex 1 and the vertex 2. The vertex 1 is located in the mesh data sub-graph 1, and the vertex 2 is located in the mesh data sub-graph 2. The vertex 1 and the vertex 2 form a to-be-connected vertex pair 1. The mesh data sub-graph 1 is connected to the mesh data sub-graph 2 based on the to-be-connected vertex pair 1. For the connection process, reference may be made to the foregoing. Update processing is performed on the connecting edges and the patches of the third graph data to obtain updated third graph data.

In this case, the updated third graph data includes three mesh data sub-graphs: a new mesh data sub-graph 1 (a new mesh data sub-graph obtained by connecting the mesh data sub-graph 1 and the mesh data sub-graph 2), a mesh data sub-graph 3, and a mesh data sub-graph 4. The preset initial determination value (1) and the iteration distance parameter (0.5) are added to obtain a connection determination value (1.5). The connection determination value is compared with the distance between any two vertexes located in different mesh data sub-graphs in the updated third graph data (including only three mesh data sub-graphs). The vertexes between which the distance is less than the connection determination value are: the vertex 3 and the vertex 4. The vertex 3 is located in the mesh data sub-graph 3, and the vertex 4 is located in the mesh data sub-graph 4. The vertex 3 and the vertex 4 form a to-be-connected vertex pair 2. The mesh data sub-graph 3 is connected to the mesh data sub-graph 4 based on the to-be-connected vertex pair 2. For the connection process, reference may be made to the foregoing. Update processing is performed on the connecting edges and the patches of the third graph data to obtain updated third graph data.

In this case, the updated third graph data includes two mesh data sub-graphs: a new mesh data sub-graph 1 (a new mesh data sub-graph obtained by connecting the mesh data sub-graph 1 and the mesh data sub-graph 2) and a new mesh data sub-graph 2 (a new mesh data sub-graph obtained by connecting the mesh data sub-graph 3 and the mesh data sub-graph 4). The connection determination value (1.5) and the iteration distance parameter (0.5) are added to obtain a new connection determination value (2). The new connection determination value is compared with the distance between any two vertexes located in different mesh data sub-graphs in the updated third graph data (including only two mesh data sub-graphs). The vertexes between which the distance is less than the connection determination value are: the vertex 5 and the vertex 6. The vertex 5 is located in the new mesh data sub-graph 1, and the vertex 6 is located in the new mesh data sub-graph 2. The vertex 5 and the vertex 6 form a to-be-connected vertex pair 3. The new mesh data sub-graph 1 is connected to the new mesh data sub-graph 2 based on the to-be-connected vertex pair 3. For the connection process, reference may be made to the foregoing. Update processing is performed on the connecting edges and the patches of the third graph data to obtain updated third graph data.

In this case, the four mesh data sub-graphs in the original third graph data are already connected, and the third graph data includes only one mesh data sub-graph. The current third graph data is used as the first graph data.

Performing smoothing processing on a plurality of unconnected mesh data sub-graphs causes abnormal distortion between different mesh data sub-graphs, and the smoothed clothing cannot reach an expected shape. Therefore, in this solution, the plurality of unconnected mesh data sub-graphs is merged into one complete connected mesh data sub-graph by updating the connecting edges and the patches through a plurality of iterations, thereby avoiding a problem of abnormal distortion in the shape of the clothing caused by smoothing processing.

803: Obtain smoothness degree indication data of the vertexes included in the first graph data.

The smoothness degree indication data may be a discrete average curvature. The discrete average curvature of any vertex may reflect a smoothness degree of curvature of a curved surface around the vertex. Lager smoothness degree indication data of the vertex indicates a sharper surface around the vertex. Smaller smoothness degree indication data of the vertex indicates a smoother surface around the vertex.

For this operation, reference may be made to the corresponding description of operation 302.

804: Perform smoothing processing on the first graph data based on the smoothness degree indication data of the vertexes, to obtain second graph data. The smoothing processing is configured for simplifying a structure of the target object.

The second graph data is graph data smoother than the first graph data. Smoothness degree indication data of vertexes in the second graph data may be smaller than smoothness degree indication data of vertexes in the first graph data. The second graph data further includes at least one mesh data sub-graph, the mesh data sub-graphs in the second graph data being connected to each other; each mesh data sub-graph including a plurality of vertexes. The number of vertexes included in the first graph data may be the same as the number of vertexes included in the second graph data.

For this operation, reference may be made to the corresponding description of operation 303.

805: Determine target weight data based on the second graph data, the target weight data being configured for indicating an association degree between each joint of the target object and the vertexes.

The target weight data may be a joint weight of a vertex. The target weight data is configured for determining degrees to which the vertex is affected by different joints during movement of the target object.

For this operation, reference may be made to the corresponding description of operation 304.

The plurality of unconnected mesh data sub-graphs is merged into one complete connected mesh data sub-graph, so that a problem of abnormal distortion in the shape of the clothing caused by smoothing processing is avoided.

In some embodiments, first graph data of a target object is obtained, the first graph data of the target object including at least one mesh data sub-graph, and the mesh data sub-graphs in the first graph data being connected to each other. If the mesh data sub-graphs in the first graph data are unconnected to each other, abnormal deformation of clothing is generated due to a large distance between the unconnected mesh data sub-graphs. Therefore, the mesh data sub-graphs included in the first graph data are connected to each other, which ensures that the abnormal deformation of the clothing is not generated due to a distance. Smoothness degree indication data of vertexes included in the first graph data is obtained, and smoothing processing is performed on the first graph data based on the smoothness degree indication data of the vertexes, to obtain second graph data. Smoothing processing is performed on the first graph data of the target object, so that proper smoothing and collapsing may be performed on a complex structure in the first graph data (for example, a wrinkled part and a puffy region of clothing). In a case of ensuring an original shape of an original smooth region of the target object does not change, a structure of the target object is simplified, so that the target object obtained based on smoothing processing has a simpler structure, and abnormal shape of clothing caused by the complex structure is avoided. Target weight data is determined based on the second graph data. Because the second graph data is data obtained based on smoothing processing, complexity of the second graph data is reduced, so that the determined target weight data is more accurate. Regardless of whether the target object includes a highly complex structure, the target weight data can be accurately determined, thereby improving the skinning effect of the target object.

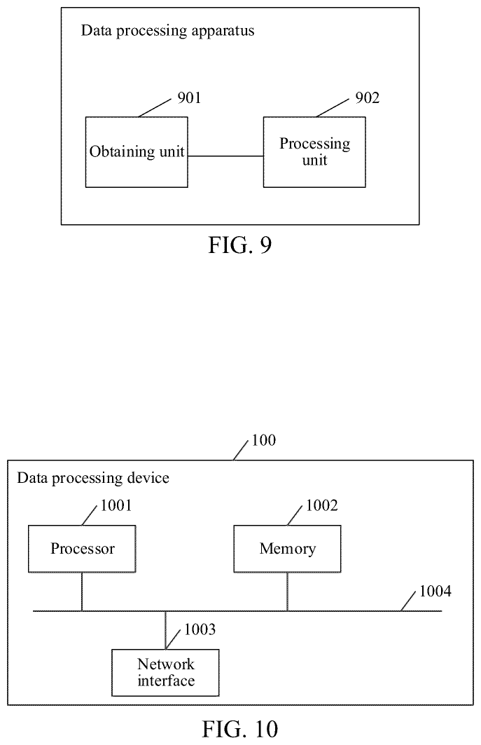

FIG. 9 is a schematic structural diagram of a data processing apparatus according to some embodiments. The data processing apparatus provided in some embodiments includes: an obtaining unit 901 and a processing unit 902.

The obtaining unit 901 is configured to obtain first graph data of a target object, the first graph data including at least one mesh data sub-graph, and the mesh data sub-graphs in the first graph data being connected to each other, each mesh data sub-graph including a plurality of vertexes.

The obtaining unit 901 is further configured to obtain smoothness degree indication data of the vertexes included in the first graph data.

The processing unit 902 is configured to perform smoothing processing on the first graph data based on the smoothness degree indication data of the vertexes, to obtain second graph data, the smoothing processing being configured for simplifying a structure of the target object.

The processing unit 902 is further configured to determine target weight data based on the second graph data, the target weight data being configured for indicating an association degree between each joint of the target object and the vertexes.

In some embodiments, the obtaining unit 901 is further configured to obtain third graph data of the target object, the third graph data including at least one mesh data sub-graph; and

the processing unit 902 is further configured to: if at least one mesh data sub-graph included in the third graph data is not connected, perform connection processing on the at least one mesh data sub-graph included in the third graph data to obtain the first graph data.

In some embodiments, the processing unit 902 is further configured to determine a to-be-connected vertex pair from the third graph data based on a preset initial connection distance value and a preset iteration accumulation distance parameter, the to-be-connected vertex pair including a first vertex and a second vertex, and the first vertex and the second vertex being located in different mesh data sub-graphs in the third graph data;
the processing unit 902 is further configured to determine, from the third graph data based on the first vertex and the second vertex, a first neighboring vertex neighboring to the first vertex and a second neighboring vertex neighboring to the second vertex; and
the processing unit 902 is further configured to perform update processing on a connecting edge and a patch of the third graph data based on the first vertex, the second vertex, the first neighboring vertex, and the second neighboring vertex, to obtain the first graph data.

In some embodiments, the processing unit 902 is further configured to determine one or more connection determination values based on the preset initial determination value and the preset iteration distance parameter;
the obtaining unit 901 is further configured to obtain a distance between any two vertexes located in different mesh data sub-graphs in the third graph data;
the processing unit 902 is further configured to determine, based on the one or more connection determination values and the distance between the any two vertexes, the first vertex and the second vertex from the vertexes included in the third graph data, and using the first vertex and the second vertex as the to-be-connected vertex pair.

In some embodiments, the smoothness degree indication data is configured for indicating a smoothness degree of curvature of a curved surface around a vertex, larger smoothness degree indication data of the vertex indicating that the curved surface around the vertex is sharper; or smaller smoothness degree indication data of the vertex indicating that the curved surface around the vertex is smoother; and
the smoothness degree indication data includes at least one of the following: a discrete average curvature, a Gaussian curvature, a normal curvature, or a principal curvature.

In some embodiments, the smoothness degree indication data includes a discrete average curvature; and the obtaining unit 901 is further configured to obtain a preset curvature threshold set, the preset curvature threshold set including K curvature thresholds, K being a positive integer greater than 1;
the processing unit 902 is further configured to perform, based on the K curvature thresholds and the discrete average curvature of the vertexes, smoothing processing on the first graph data, to obtain K pieces of smooth graph data; and
the processing unit 902 is further configured to determine the second graph data based on K pieces of smooth graph data.

In some embodiments, the processing unit 902 is further configured to determine, from the first graph data based on an i^{th} curvature threshold in the preset curvature threshold set, a to-be-adjusted vertex with the discrete average curvature greater than the i^{th} curvature threshold, i being a positive integer greater than 0 and less than or equal to K; and
the processing unit 902 is further configured to adjust a position of the to-be-adjusted vertex based on a preset adjustment policy to obtain smooth graph data corresponding to the i^{th} curvature threshold.

In some embodiments, the processing unit 902 is further configured to respectively calculate the vertex average curvature corresponding to each smooth graph data in the K pieces of smooth graph data, to obtain K vertex average curvatures; and
the processing unit 902 is further configured to determine the second graph data from the K pieces of smooth graph data based on the K vertex average curvatures.

In some embodiments, the processing unit 902 is further configured to select the vertex average curvature with a smallest value from the K vertex average curvatures, and determine the smooth graph data corresponding to the vertex average curvature with the smallest value as the second graph data,
the vertex average curvature including any one of the following: an average value, a median, or a variance of the discrete average curvatures of the vertexes in the smooth graph data.

In some embodiments, the processing unit 902 is further configured to obtain a preset curvature threshold mapping table, the preset curvature threshold mapping table including a mapping relationship between a curvature threshold and a vertex average curvature range;
the processing unit 902 is further configured to calculate a vertex average curvature corresponding to the first graph data;
the processing unit 902 is further configured to determine a target curvature threshold based on the vertex average curvature and the preset curvature threshold mapping table; and
the processing unit 902 is further configured to perform smoothing processing on the first graph data based on the target curvature threshold, and use the processed first graph data as the second graph data.

In some embodiments, the processing unit 902 is further configured to perform feature extraction on the second graph data to obtain target feature data; and

the processing unit 902 is further configured to call a target network model to perform prediction processing on the target feature data to obtain the target weight data, the target network model being obtained by training an initialized neural network based on sample graph data of a sample object and annotated weight data, and the sample graph data being obtained by performing connection processing and smoothing processing on the sample graph data of the sample object.

In some embodiments, the processing unit 902 is further configured to perform skinning processing on the target object based on the target weight data.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

Functions modules or units of the data processing apparatus according to some embodiments may be implemented based on the foregoing method according to some embodiments.

The data processing apparatus provided in some embodiments may be implemented by using a combination of software and hardware. For example, the data processing apparatus provided in some embodiments may be a processor in a form of a hardware decoding processor, programmed to perform the data processing method provided in some embodiments. For example, the processor in the form of a hardware decoding processor may use one or more application specific integrated circuits (ASICs), a DSP, a programmable logic device (PLD), a complex programmable logic device (CPLD), a field-programmable gate array (FPGA), or another electronic component.

In some embodiments, first graph data of a target object is obtained, the first graph data of the target object including at least one mesh data sub-graph, and the mesh data sub-graphs in the first graph data being connected to each other. If the mesh data sub-graphs in the first graph data are unconnected to each other, abnormal deformation of clothing is generated due to a large distance between the unconnected mesh data sub-graphs. Therefore, the mesh data sub-graphs included in the first graph data are connected to each other, which ensures that the abnormal deformation of the clothing is not generated due to a distance. Smoothness degree indication data of vertexes included in the first graph data is obtained, and smoothing processing is performed on the first graph data based on the smoothness degree indication data of the vertexes, to obtain second graph data. Smoothing processing is performed on the first graph data of the target object, so that proper smoothing and collapsing may be performed on a complex structure in the first graph data (for example, a wrinkled part and a puffy region of clothing). In a case of ensuring an original shape of an original smooth region of the target object does not change, a structure of the target object is simplified, so that the target object obtained based on smoothing processing has a simpler structure, and abnormal shape of clothing caused by the complex structure is avoided. Target weight data is determined based on the second graph data. Because the second graph data is data obtained based on smoothing processing, complexity of the second graph data is reduced, so that the determined target weight data is more accurate. Regardless of whether the target object includes a highly complex structure, the target weight data can be accurately determined, thereby improving the skinning effect of the target object.

FIG. 10 is a schematic structural diagram of a data processing device according to some embodiments. The data processing device 100 may include a processor 1001, a memory 1002, a network interface 1003, and at least one communication bus 1004. The processor 1001 is configured to schedule a computer program, and may include a central processing unit, a controller, and a microprocessor. The memory 1002 is configured to store a computer program, and may include a high speed random access memory RAM, and a non-volatile memory, such as a magnetic disk storage device or a flash storage device. In some embodiments, the network interface 1003 may include a standard wired interface and wireless interface (for example, a Wi-Fi interface), and is configured to provide a data communication function. The communication bus 1004 is responsible for connecting various communication components. The memory 1002 is configured to store a computer program. The computer program includes program instructions. The processor 1001 is configured to execute the program instructions stored in the memory 1002, to perform the process described in operation 301 to operation 304 in the foregoing embodiments, and perform the following operations.

In an implementation, first graph data of a target object is obtained, the first graph data including at least one mesh data sub-graph, and the mesh data sub-graphs in the first graph data being connected to each other, each mesh data sub-graph including a plurality of vertexes;
smoothness degree indication data of the vertexes included in the first graph data is obtained;
smoothing processing is performed on the first graph data based on the smoothness degree indication data of the vertexes, to obtain second graph data; and
target weight data is determined based on the second graph data, the target weight data being configured for indicating an association degree between each joint of the target object and the vertexes.

In some embodiments, the foregoing data processing device may perform the implementations provided in the operations in FIG. 3 through built-in computer programs of the data processing device. For details, reference may be made to the implementations provided in the foregoing operations.

Some embodiments provide a computer-readable storage medium, the computer-readable storage medium having a computer program stored therein, the computer program including program instructions, the program instructions, when executed by a processor, performing the data processing method provided in the operations in FIG. 3. For details, reference may be made to the implementations provided in the foregoing operations.

The computer-readable storage medium may be an internal storage unit of the data processing apparatus or the terminal device provided in any one of the foregoing embodiments, for example, a hard disk or a main memory of the electronic device. The computer-readable storage medium may be an external storage device of the electronic device, for example, a removable hard disk, a smart media card (SMC), a secure digital (SD) card, or a flash card equipped on the electronic device. Further, the computer-readable storage medium may further include both an internal storage unit and an external storage device of the electronic device. The computer-readable storage medium is configured to store the computer program and other programs and data for the electronic device. The computer-readable storage medium may further be configured to temporarily store data that has been outputted or data to be outputted.

In the disclosure, the terms “first”, “second”, “third”, “fourth”, or the like are intended to distinguish between different objects and are not used to describe a particular order. In addition, the terms “comprise”, “have”, and any variations thereof are intended to indicate non-exclusive inclusion. For example, a process, method, system, product, or device that includes a series of operations or units is not limited to the listed operations or units; and instead, may further include an operation or unit that is not listed, or may further include another operation or unit that is inherent to the process, method, product, or device.

In some embodiments, data related to user information (for example, first graph data of a target object) is involved. When some embodiments are applied to products or technologies, permission or consent of a user may need to be obtained, and collection, use, and processing of the relevant data may need to comply with relevant laws, regulations, and standards of relevant countries and regions.

The method and the related apparatus provided in some embodiments are described with reference to method flowcharts and/or schematic structural diagrams provided in some embodiments. Computer program instructions may be used to implement each process and/or each block in the method flowcharts and/or the schematic structural diagrams and a combination of a process and/or a block in the flowcharts and/or the block diagrams. These computer program instructions may be provided to a computer, a dedicated computer, an embedded processor, or a processor of another programmable data processing device to generate a machine, so that the instructions executed by the computer or the processor of the another programmable data processing device generate an apparatus for implementing a function in one or more processes in the flowcharts and/or in one or more blocks in the schematic structural diagrams. These computer program instructions may be stored in a computer-readable memory that can instruct a computer or another programmable data processing device to work in a manner, so that the instructions stored in the computer-readable memory generate an artifact that includes an instruction apparatus. The instruction apparatus implements a function in one or more procedures in the flowcharts and/or in one or more blocks in the schematic structural diagrams. These computer program instructions may also be loaded onto a computer or another programmable data processing device, so that a series of operations are performed on the computer or the another programmable device, thereby generating computer-implemented processing. Therefore, the instructions executed on the computer or the another programmable device provide operations for implementing a function in one or more processes in the flowcharts and/or in one or more blocks in the schematic structural.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data processing method, performed by a data processing device, comprising:
obtaining first graph data of a target object, the first graph data comprising at least one first mesh data sub-graph comprising a plurality of vertexes, wherein each of the at least one first mesh data sub-graph are connected to each other;
obtaining smoothness degree data of the plurality of vertexes;
obtaining second graph data by performing smoothing processing on the first graph data based on the smoothness degree data, the smoothing processing comprising simplifying a structure of the target object; and
determining target weight data based on the second graph data, wherein the target weight data indicates an association degree between one or more joints of the target object and the plurality of vertexes.

2. The method according to claim 1, wherein the obtaining the first graph data comprises:
obtaining third graph data of the target object comprising at least one second mesh data sub-graph; and
based on at least one of the at least one second mesh data sub-graph not being connected to another mesh data sub-graph of the at least one second mesh data sub-graph, performing connection processing on the at least one of the at least one second mesh data sub-graph to obtain the first graph data.

3. The method according to claim 2, wherein the performing the connection processing comprises:
determining a to-be-connected vertex pair from the third graph data based on a preset initial connection distance value and a preset iteration accumulation distance parameter, the to-be-connected vertex pair comprising a first vertex and a second vertex, and the first vertex and the second vertex being located in different mesh data sub-graphs of the third graph data;
determining, from the third graph data, based on the first vertex and the second vertex, a first neighboring vertex neighboring to the first vertex and a second neighboring vertex neighboring to the second vertex; and
performing update processing on a connecting edge of the third graph data and a patch of the third graph data based on the first vertex, the second vertex, the first neighboring vertex, and the second neighboring vertex, to obtain the first graph data.

4. The method according to claim 3, wherein the determining the to-be-connected vertex pair comprises:
determining one or more connection determination values based on the preset initial connection distance value and the preset iteration accumulation distance parameter;
obtaining a distance between two vertexes in different mesh data sub-graphs of the third graph data;
determining the first vertex and the second vertex based on the one or more connection determination values and the distance between the two vertexes; and
using the first vertex and the second vertex as the to-be-connected vertex pair.

5. The method according to claim 1, wherein the smoothness degree data indicates:
a smoothness degree of curvature of a curved surface around a vertex,
larger smoothness degree data of the vertex indicating increased sharpness of the curved surface around the vertex, or
smaller smoothness degree data of the vertex indicating increased smoothness of the curved surface around the vertex, and
wherein the smoothness degree data comprises at least one of: a discrete average curvature, a Gaussian curvature, a normal curvature, or a principal curvature.

6. The method according to claim 1, wherein the smoothness degree data comprises a discrete average curvature, and
wherein the obtaining the second graph data comprises:
obtaining a preset curvature threshold set comprising a plurality of curvature thresholds;
performing, based on the plurality of curvature thresholds and the discrete average curvature, smoothing processing on the first graph data, to obtain a plurality of smooth graph data pieces; and
determining the second graph data based on the plurality of smooth graph data pieces.

7. The method according to claim 6, wherein the performing the smoothing processing to obtain the plurality of smooth graph data pieces comprises:
determining, from the first graph data based on an i^{th} curvature threshold in the preset curvature threshold set, a to-be-adjusted vertex with the discrete average curvature greater than the i^{th} curvature threshold, wherein i is a positive integer greater than 0 and less than or equal to a number of the plurality of smooth graph data pieces; and
adjusting a position of the to-be-adjusted vertex based on a preset adjustment policy to obtain smooth graph data corresponding to the i^{th} curvature threshold.

8. The method according to claim 6, wherein the determining the second graph data based on the plurality of smooth graph data pieces comprises:
respectively calculating a vertex average curvature corresponding to each smooth graph data in the plurality of smooth graph data pieces, to obtain a plurality of vertex average curvatures; and
determining the second graph data from the plurality of smooth graph data pieces based on the plurality of vertex average curvatures.

9. The method according to claim 8, wherein the determining the second graph data from the plurality of smooth graph data pieces based on the plurality of vertex average curvatures comprises selecting the vertex average curvature with a smallest value from the plurality of vertex average curvatures, and determining the smooth graph data corresponding to the vertex average curvature with the smallest value as the second graph data, and
wherein the vertex average curvature comprises: an average value, a median, or a variance of discrete average curvatures of vertexes of the smooth graph data.

10. The method according to claim 1, wherein the obtaining the second graph data comprises:
obtaining a preset curvature threshold mapping table comprising a mapping relationship between a curvature threshold and a vertex average curvature range;
calculating a vertex average curvature corresponding to the first graph data;
determining a target curvature threshold based on the vertex average curvature and the preset curvature threshold mapping table;
performing smoothing processing on the first graph data based on the target curvature threshold to obtain processed first graph data; and
using the processed first graph data as the second graph data.

11. A data processing apparatus, comprising:
at least one memory configured to store computer program code; and
at least one processor configured to read the program code and operate as instructed by the program code, the program code comprising:
first obtaining code configured to cause at least one of the at least one processor to obtain first graph data of a target object, the first graph data comprising at least one first mesh data sub-graph comprising a plurality of vertexes, wherein each of the at least one first mesh data sub-graph are connected to each other;
second obtaining code configured to cause at least one of the at least one processor to obtain smoothness degree data of the plurality of vertexes;
first processing code configured to cause at least one of the at least one processor to obtain second graph data by performing smoothing processing on the first graph data based on the smoothness degree data of the plurality of vertexes, the smoothing processing comprising simplifying a structure of the target object; and
second processing code configured to cause at least one of the at least one processor to determine target weight data based on the second graph data, wherein the target weight data indicates an association degree between one or more joints of the target object and the plurality of vertexes.

12. The apparatus according to claim 11, wherein the first obtaining code comprises:
third obtaining code configured to cause at least one of the at least one processor to obtain third graph data of the target object comprising at least one second mesh data sub-graph; and
third processing code configured to cause at least one of the at least one processor to, based on at least one of the at least one second mesh data sub-graph not being connected to another mesh data sub-graph of the at least one second mesh data sub-graph, perform connection processing on the at least one of the at least one second mesh data sub-graph to obtain the first graph data.

13. The apparatus according to claim 12, wherein the third processing comprises:
first determining code configured to cause at least one of the at least one processor to determine a to-be-connected vertex pair from the third graph data based on a preset initial connection distance value and a preset iteration accumulation distance parameter, the to-be-connected vertex pair comprising a first vertex and a second vertex, and the first vertex and the second vertex being located in different mesh data sub-graphs of the third graph data;
second determining code configured to cause at least one of the at least one processor to determine, from the third graph data, based on the first vertex and the second vertex, a first neighboring vertex neighboring to the first vertex and a second neighboring vertex neighboring to the second vertex; and
fourth processing code configured to cause at least one of the at least one processor to perform update processing on a connecting edge of the third graph data and a patch of the third graph data based on the first vertex, the second vertex, the first neighboring vertex, and the second neighboring vertex, to obtain the first graph data.

14. The apparatus according to claim 13, wherein the first determining code is configured to cause at least one of the at least one processor to:
determine one or more connection determination values based on the preset initial connection distance value and the preset iteration accumulation distance parameter;
obtain a distance between two vertexes in different mesh data sub-graphs of the third graph data;
determine the first vertex and the second vertex based on the one or more connection determination values and the distance between the two vertexes; and
use the first vertex and the second vertex as the to-be-connected vertex pair.

15. The apparatus according to claim 11, wherein the smoothness degree data indicates:
a smoothness degree of curvature of a curved surface around a vertex,
larger smoothness degree data of the vertex indicating increased sharpness of the curved surface around the vertex, or
smaller smoothness degree data of the vertex indicating increased smoothness of the curved surface around the vertex, and
wherein the smoothness degree data comprises at least one of: a discrete average curvature, a Gaussian curvature, a normal curvature, or a principal curvature.

16. The apparatus according to claim 11, wherein the smoothness degree data comprises a discrete average curvature, and
wherein the first processing code comprises:
obtaining code configured to cause at least one of the at least one processor to obtain a preset curvature threshold set comprising a plurality of curvature thresholds;
third processing code configured to cause at least one of the at least one processor to perform, based on the plurality of curvature thresholds and the discrete average curvature, smoothing processing on the first graph data, to obtain a plurality of smooth graph data pieces; and
first determining code configured to cause at least one of the at least one processor to determine the second graph data based on the plurality of smooth graph data pieces.

17. The apparatus according to claim 16, wherein the third processing code is configured to cause at least one of the at least one processor to:
determine, from the first graph data based on an i^{th} curvature threshold in the preset curvature threshold set, a to-be-adjusted vertex with the discrete average curvature greater than the i^{th} curvature threshold, wherein i is a positive integer greater than 0 and less than or equal to a number of the plurality of smooth graph data pieces; and
adjust a position of the to-be-adjusted vertex based on a preset adjustment policy to obtain smooth graph data corresponding to the i^{th} curvature threshold.

18. The apparatus according to claim 16, wherein the first determining comprises:
calculation code configured to cause at least one of the at least one processor to respectively calculate a vertex average curvature corresponding to each smooth graph data in the plurality of smooth graph data pieces, to obtain a plurality of vertex average curvatures; and
second determining code configured to cause at least one of the at least one processor to determine the second graph data from the plurality of smooth graph data pieces based on the plurality of vertex average curvatures.

19. The apparatus according to claim 18, wherein the second determining code is configured t cause at least one of the at least one processor to select the vertex average curvature with a smallest value from the plurality of vertex average curvatures, and determining the smooth graph data corresponding to the vertex average curvature with the smallest value as the second graph data, and
wherein the vertex average curvature comprises: an average value, a median, or a variance of discrete average curvatures of vertexes of the smooth graph data.

20. A non-transitory computer-readable storage medium, storing computer code which, when executed by at least one processor, causes the at least one processor to at least:
obtain first graph data of a target object, the first graph data comprising at least one first mesh data sub-graph comprising a plurality of vertexes, wherein each of the at least one first mesh data sub-graph are connected to each other;
obtain smoothness degree data of the plurality of vertexes;
obtain second graph data by performing smoothing processing on the first graph data based on the smoothness degree data of the plurality of vertexes, the smoothing processing comprising simplifying a structure of the target object; and
determine target weight data based on the second graph data, wherein the target weight data indicates an association degree between one or more joints of the target object and the plurality of vertexes.
